(19) United States
(12) Patent Application Publication
(10) Pub. No.: US 2022/0311055 A1
(43) Pub. Date: Sep. 29, 2022

(54) LITHIUM-ION BATTERY AND METHOD FOR THE MANUFACTURE THEREOF

(71) Applicant: I-TEN, DARDILLY (FR)

(72) Inventor: Fabien GABEN, DARDILLY (FR)

(21) Appl. No.: 17/618,046

(22) PCT Filed: Jun. 9, 2020
(86) PCT No.: PCT/FR2020/000184

§ 371 Date: Dec. 10, 2021

(30) Foreign Application Priority Data
Jun. 13, 2019 (FR) 1906289

(51) Int. Cl. H01M 10/0585; H01M 10/0525; H01M 50/121; H01M 50/534

(52) U.S. Cl. CPC H01M 10/0585; H01M 10/0525; H01M 50/121; H01M 50/534

(57) ABSTRACT

A battery (1000) comprising an elementary cell (100) that comprises, in succession, a planar anode current collector substrate (10), an anode layer (20), a layer of an electrolyte material (30) or of a separator impregnated with an electrolyte (31), a cathode layer (50), and a planar cathode current collector substrate (40), said battery (1000) also comprising longitudinal edges (1011, 1012), a first lateral edge (1001) comprising an anode connection area (1002) and a second lateral edge (1005) comprising a cathode connection area (1006). Each elementary cell (100) comprises a primary body (111), a secondary body (112) and a tertiary body (113), said secondary body and said tertiary body being arranged on either side of said primary body, it being understood that each of the primary (111), secondary (112) and tertiary (113) bodies comprises, in succession, a planar anode current collector substrate (10), an anode layer (20), a layer of an electrolyte material (30) or of a separator impregnated with an electrolyte (31), a cathode layer (50), and a planar cathode current collector substrate (40). Said secondary body (112) is separated from the primary body (111) by a notch (120) free from any anode, electrolyte, cathode and anode current collector substrate material. Said notch extends from a longitudinal edge (1011) to the opposite longitudinal edge of the battery (1012) in a direction perpendicular to the main plane of the battery. Said tertiary body (113) is separated from the primary body (111) by a recess (130) free from any anode, electrolyte, cathode and cathode current collector substrate material. Said recess (130) extends from a longitudinal edge (1011) to the opposite longitudinal edge of the battery (1012) in a direction perpendicular to the main plane of the battery.

### CROSS-REFERENCE TO RELATED APPLICATIONS

The present application is a National Stage Application of PCT International Application No. PCT/FR2020/000184 (filed on Jun. 9, 2020), under 35 U.S.C. § 371, which claims priority to French Patent Application No. 1906289 (filed on Jun. 13, 2019), which are each hereby incorporated by reference in their complete respective entireties.

### TECHNICAL FIELD

The present invention relates to the field of batteries, and more particularly to lithium-ion batteries. The invention relates to lithium-ion batteries with a new architecture that provides them with an improved service life. The invention also relates to a new method for manufacturing such batteries.

### PRIOR ART

All-solid-state lithium-ion rechargeable batteries are known. WO 2016/001584 (I-TEN) describes a lithium-ion battery manufactured from anode foils comprising a conductor substrate covered successively with an anode layer and an electrolyte layer, and cathode foils comprising a conductor substrate covered successively with a cathode layer and an electrolyte layer; these foils are cut, before or after deposition, according to U-shaped patterns. These foils are then stacked alternately so as to constitute a stack of several elementary cells. The patterns of the cuts of the anode and cathode foils are placed in a “head-to-tail” configuration in such a way that the stack of cathodes and anodes is offset laterally. After the step of stacking, an encapsulation system with a layer with a thickness of about ten microns is deposited on the stack and in the cavities available present within the stack. This makes it possible to ensure, on the one hand, the rigidity of the structure at the cutting planes and, on the other hand, the protection of the cell of the battery with regards to the atmosphere. Once the stack is carried out and encapsulated, it is cut according to the cutting planes in order to obtain unitary batteries, with the exposing on each one of the cutting planes of the cathode connection areas and of the anode connection areas of the batteries. It happens that during these cuttings, the encapsulation system can be pulled off, which results in a discontinuity of the tightness of the battery. It is also known to add terminations (i.e. electrical contacts) at the location where these cathode and anode connections areas are apparent.

It has appeared that this known solution can however have certain disadvantages. Indeed, according to the positioning of the electrodes, in particular of the proximity of the edges of the electrodes for multilayer batteries and of the cleanliness of the cuts, a leakage current can appear at the ends, typically in the form of a rampant short-circuit. This rampant short-circuit decreases the performance of the battery, and this, despite the use of an encapsulation system around the battery and at the approaches to the cathode and anode connection areas. Moreover, an unsatisfactory deposition of the encapsulation system on the battery is sometimes observed, in particular on the edges of the battery at the spaces created by the lateral offsets of the electrodes on the battery edges.

Moreover, given that the terminations, respectively anode and cathode, are located retracted from the adjacent, respectively cathode and anode, foils, it is necessary to made a cut of large dimensions. Such a cut must then be filled using an insulating material. Given its substantial dimensions, this cut leads to a substantial loss of material useful for the carrying out of the battery strictly speaking. Moreover, it imposes depositing high thicknesses of insulator, in the cavities available present within the stack. A thick insulator risks weakening the entire encapsulation system of the battery. During the cutting, the encapsulation system deposited as a thick layer tends to delaminate. The architecture according to the prior art therefore has certain technical but also economic disadvantages.

The present invention aims to overcome at least partially certain disadvantages of the prior art mentioned hereinabove, in particular obtaining rechargeable lithium-ion batteries with a high energy density and high power density.

It aims in particular to increase the production yield of rechargeable lithium-ion batteries with a high energy density and high power density, and to carry out higher-efficiency encapsulations at least cost.

It aims in particular to propose a method that decreases the risk of a rampant or accidental short-circuit and that makes it possible to manufacture a battery that has a low self-discharge.

It aims in particular to propose a method, that makes it possible to simply, reliably and quickly manufacture a battery that has a very high service life.

It also aims to propose such a method, that uses a better quality cutting step, in particular cleaner than in the prior art.

It also aims to propose a method for manufacturing batteries that generates less loss of materials.

### SUMMARY

A first object of the invention is a battery 1000 comprising at least one elementary cell 100, said elementary cell 100 comprising successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40, said battery 1000 comprising longitudinal edges 1011, 1012, a first lateral edge 1001 comprising at least one anode connection area 1002 and a second lateral edge 1005 comprising at least one cathode connection area 1006, said anode 1002 and cathode 1006 connection areas being preferably laterally opposite, characterized in that each elementary cell 100 comprises a primary body 111, a secondary body 112 and a tertiary body 113, said secondary body and said tertiary body being arranged on either side of said primary body, with the understanding that each one of the primary 111, secondary 112 and tertiary 113 bodies comprises successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40, said secondary body 112 being separated from the primary body 111 by a notch 120 free from any anode, electrolyte, separator impregnated with an electrolyte, cathode and anode current collector substrate material, with the understanding that said notch extends from a longitudinal edge 1011 to the opposite longitudinal edge of the battery 1012 in a direction perpendicular to the main plane of the battery, and said tertiary body 113 being separated from the primary body 111 by a recess 130 free from any anode, electrolyte, separator impregnated with an electrolyte, cathode and cathode current collector substrate material, with the understanding that said recess 130 extends from a longitudinal edge 1011 to the opposite longitudinal edge of the battery 1012 in a direction perpendicular to the main plane of the battery.

Advantageously, the battery according to the invention comprises a plurality of elementary cells, and is characterized in that all the notches of each one of the elementary cells are superimposed, in a direction perpendicular to the main plane of the battery, in such a way that each planar cathode current collector substrate collects the cathode current of the elementary cell through the cathode connection area, and in that all the recesses of each one of the elementary cells are superimposed, in a direction perpendicular to the main plane of the battery, in such a way that each planar anode current collector substrate collects the anode current of the elementary cell through the anode connection area.

In a preferred embodiment, said battery is a lithium-ion battery. Advantageously, the battery according to the invention comprises an encapsulation system entirely covering four of the six faces of said battery, the two remaining faces comprising an anode connection area and a cathode connection area. Advantageously the encapsulation system comprises: at least one first cover layer, preferably selected from parylene, parylene F, polyimide, epoxy resins, silicone, polyamide, sol-gel silica, organic silica and/or a mixture thereof, deposited on the battery, and at least one second cover layer comprised of an electrically-insulating material, deposited by atomic layer deposition on said at least first cover layer, with the understanding that this sequence of at least one first cover layer and of at least one second cover layer can be repeated z times with z ≥1.

Advantageously, the anode connection area and the cathode connection area are covered by terminations.

Advantageously, the terminations comprise: a first layer of a material loaded with graphite, preferably with an epoxy resin base loaded with graphite disposed on at least the cathode connection area and/or at least the anode connection area, a second dense layer of metal copper disposed on the first layer of the termination system, optionally, a third layer with a tin-tin zinc alloy base, disposed on the second layer, and optionally, a fourth layer with a tin base or with a base of a silver, palladium and copper alloy, disposed on the third layer of the termination system.

Advantageously, the width of said notch is comprised between 0.01 mm and 0.5 mm.

Advantageously, the width of said recess is comprised between 0.01 mm and 0.5 mm.

Advantageously, the width of the secondary bodies is comprised between 0.5 mm and 20 mm. A second object of the invention is a method for manufacturing a battery 1000, said battery comprising at least one elementary cell 100, said elementary cell 100 comprising successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40, said method of manufacturing comprising:

(a) the providing of at least one foil of planar anode current collector substrate 10 covered with an anode layer 20, and optionally covered with a layer of an electrolyte material 30 or of a separator impregnated with an electrolyte 31, called hereinafter anode foil 2, said anode foil comprising at least one anode slot 80, said anode slot 80 comprising two main vertical anode and parallel cavities 82, which are connected in their upper portion by a horizontal anode channel 84, substantially perpendicular to the two main anode vertical cavities 82, these main vertical anode cavities being intended for delimiting the longitudinal edges of the battery,

(b) the providing of at least one foil of planar cathode current collector substrate 40 covered with a cathode layer 50, and optionally covered with a layer of an electrolyte material 30 or of a separator impregnated with an electrolyte 31, called hereinafter cathode foil 5, said cathode foil comprising at least one cathode slot 70, said cathode slot comprising two main vertical cathode and parallel cavities 72, which are connected in their upper portion by a horizontal cathode channel 74, substantially perpendicular to the two main vertical cathode cavities 72, these main vertical cathode cavities being intended for delimiting the longitudinal edges of the battery,

(c) the carrying out of a first and of a second notches, in the vicinity of each anode 80, respectively cathode 70, slot of at least the foil supplied in step a), respectively in step b), in such a way as to form anode trenches 86, 88, respectively cathode trenches 76, 78, in a direction perpendicular to the main plane of the battery and in a direction parallel to the horizontal anode channel 84, of the anode slot 80, respectively to the horizontal cathode channel 74 of the cathode slot 70, with the understanding that: the first and second notches are made on either side of the anode 2, respectively cathode 5, foil, the second notch is made in the extension of the first notch, and the anode trenches 86, 88, respectively the cathode trenches 76, 78, obtained from the first and second notches are free from any electrolyte material or separator impregnated with an electrolyte and from any anode material, respectively are free from any electrolyte material or separator impregnated with an electrolyte and from any cathode material, and said anode trenches 86, 88, respectively the cathode trenches 76, 78 extend between the opposite longitudinal edges 1011, 1012 of the battery in a direction perpendicular to the main plane of the battery in such a way as to connect the two main vertical anode and parallel cavities of each anode slot 80, respectively to connect the two main vertical cathode and parallel cavities of each cathode slot 70, the foil obtained after the carrying out of these notches being called hereinafter notched anode foil 2e, respectively notched cathode foil 5e,

(d) the carrying out of an alternating stack I of at least one notched anode foil 2e and of at least one notched cathode foil 5e, in such a way as to obtain successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40; in such way that, for each anode slot 80 of at least one notched anode foil 2e, respectively for each cathode slot 70 of at least one notched cathode foil 5e, the anode trenches 86, 88 of at least the notched anode foil, respectively the cathode trenches 76, 78, of at least the notched cathode foil 5e, are disposed in the extension of the horizontal cathode channel 74 of the cathode slot 70 of the adjacent notched cathode foil 5e, respectively of the horizontal anode channel 84 of the anode slot 80, of the adjacent notched anode foil 2e in a direction perpendicular to the main plane of the battery,

(e) the carrying out of a heat treatment and/or of a mechanical compression of the stack of alternating foils obtained in step d), in such a way as to form a consolidated stack,

(f) the carrying out of two cuts Dn, D′n extending at least partially inside said anode 80, respectively cathode 70 slot, according to a plane parallel to the horizontal anode 84, respectively cathode 74 channel, the first cut extending between the horizontal anode channel 84 of the anode slot 80 and the end facing the longitudinal edges, while the second cut extends between the horizontal cathode channel 74 of the cathode slot 70 and the end facing the longitudinal edges, in such a way as to form a cut stack exposing at least the anode and cathode connection areas.

Advantageously, after step (e), and preferably before step (f), a step (g) of encapsulating the consolidated stack is carried out, by depositing: at least one first cover layer, preferably selected from parylene, parylene F, polyimide, epoxy resins, silicone, polyamide, sol-gel silica, organic silica and/or a mixture thereof, on the battery, and then at least one second cover layer comprised of an electrically-insulating material, deposited by atomic layer deposition on said at least first cover layer, with the understanding that the sequence of at least one first cover layer and of at least one second cover layer can be repeated z times with z ≥1.

Advantageously, when a separator is used in the batteries according to the invention, the separator is impregnated by an electrolyte, preferably, by a lithium ion carrier phase such as liquid electrolytes or an ionic liquid containing lithium salts.

Advantageously, after step (f), the terminations of the battery are carried out by depositing successively on at least the anode and cathode connection areas: a first layer of a material loaded with graphite, preferably with an epoxy resin base loaded with graphite, a second dense layer of metal copper disposed on the first layer of the termination system, and optionally, a third layer with a tin-zinc alloy base, disposed on the second layer of the termination system, and optionally, a fourth layer with a tin base or with a base of a silver, palladium and copper alloy, disposed on the third layer of the termination system.

Advantageously, the two notches made in step (d) forming trenches 76, 78, 86, 88 are carried out via laser ablation.

Advantageously, each cut is carried out via laser.

Advantageously, each elementary cell defines on a first face, a continuity area of the planar anode current collector substrate and an emerging notch 120, and on the opposite face, a continuity area of the planar cathode current collector substrate and an emerging recess 130.

Advantageously, the continuity area of the planar anode current collector substrate is located facing the notch 120, and the continuity area of the planar cathode current collector substrate is located facing the recess 130 in a direction perpendicular to the plane of the battery.

Advantageously, the battery according to the invention is characterized in that: the planar anode current collector substrate is the anode current collector substrate of two adjacent elementary cells, and in that the planar cathode current collector substrate is the cathode current collector substrate of two adjacent elementary cells.

### DRAWINGS

The accompanying figures, given as non-limiting examples, represent different aspects and embodiments of the invention.

FIG. 1 is a perspective view of the notched anode and notched cathode foils intended for forming a stack according to the method for the manufacturing of batteries in accordance with the invention.

FIG. 2 is a front view, showing one of the foils of FIG. 1.

FIG. 3 is a front view, on a larger scale, showing a ladder-shaped groove arranged in an anode foil.

FIG. 4 is a perspective view, also on a large scale, showing these ladder-shaped grooves arranged in adjacent foils.

FIG. 5 is a top view, showing a step of cutting carried out on different grooves arranged in the stack of the preceding figures.

FIG. 6 is a top view, showing on a larger scale the cuts arranged on a ladder-shaped groove.

FIG. 7 is a cross-section view, according to the line VII-VII indicated in FIG. 6.

FIG. 8 is a cross-section view, according to the line VII-VII indicated in FIG. 6.

FIG. 9 is an exploded cross-section view, according to the line VII-VII indicated in FIG. 6 showing a stack comprised of three elementary cells.

FIG. 10 is a top view showing a battery in accordance with the invention, that is able to be obtained in particular according to the method of the preceding figures.

FIG. 11 is a front view showing a battery in accordance with the invention, that is able to be obtained in particular according to the method of the preceding figures.

FIG. 12 is a perspective view showing a battery in accordance with the invention, that is able to be obtained in particular according to the method of the preceding figures.

FIG. 13 is a perspective view showing a battery according to the prior art.

### DESCRIPTION

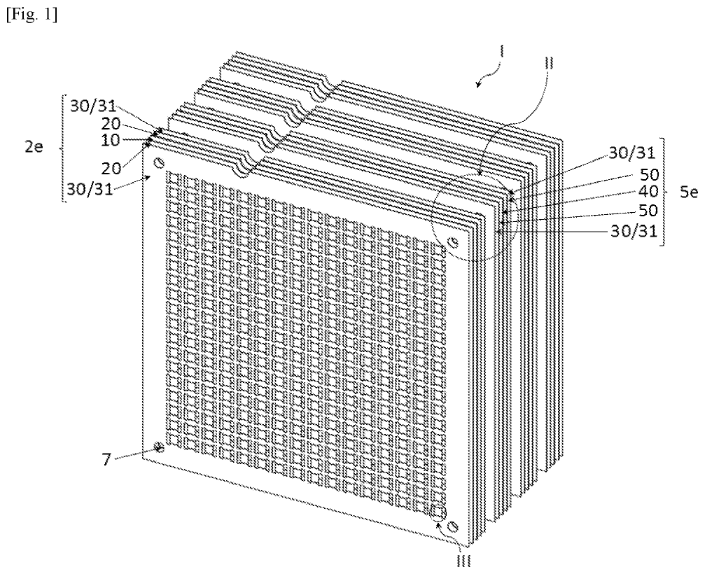

The method in accordance with the invention comprises first of all a step wherein a stack I of alternating foils is carried out, these foils being called hereinafter, according to the case, “anode foils” 2 or “cathode foils” 5. As shall be seen in more detail, each anode foil 2 is intended for forming the anode of several batteries, and each cathode foil 5 is intended for forming the cathode of several batteries. In the example shown in FIG. 1, two notched cathode foils 5e are shown, as well as two notched anode foils 2e. In practice, this stack is formed by a higher number of foils, typically comprised between ten and thousand. The number of notched cathode foils 5e is identical to the number of notched anode foils 2e used constituting the stack I of alternating foils of opposite polarity.

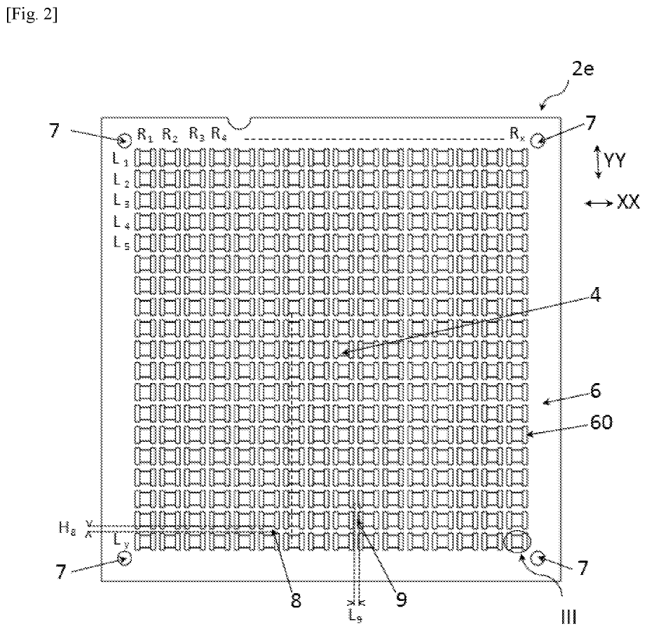

In an advantageous embodiment, each one of these foils has perforations 7 at its four ends in such a way that when these perforations 7 are superimposed, all the cathodes and all the anodes of these foils are arranged specifically, as shall be explained in greater detail hereinafter (cf. FIGS. 1 and 2). These perforations 7 at the four ends of the foils can be carried out by any suitable means, in particular on anode 2 and cathode 5 foils after manufacture, or on substrate foils 10, 40 covered with a cathode 50 or anode 20 layer, and optionally covered with a layer of an electrolyte material 30 or of a separator 31 in such a way that this layer of an electrolyte material 30 or this separator 31 is inserted between two foils of opposite polarity, i.e. between the anode foil 2 and the cathode foil 5.

Each anode foil 2 comprises a planar anode current collector substrate 10 covered with an active layer of an anode material 20, hereinafter anode layer 20. Each cathode foil 5 comprises a planar cathode current collector substrate 40 covered with an active layer of a cathode material 50, called hereinafter cathode layer 50. Each one of these active layers can be solid, and more particularly of a dense or porous nature. Moreover, in order to prevent any electrical contact between two active layers of opposite polarities, a layer of electrolyte 30 or of a separator 31 impregnated with an electrolyte is disposed on the active layer of at least one of these planar cathode current collector substrates covered beforehand with the active layer, in contact with the active layer facing. The layer of electrolyte 30 or the separator 31, can be disposed on the anode layer 20 and/or on the cathode layer 50; the layer of electrolyte or the separator is an integral part of the anode foil 2 and/or of the cathode foil 5 that comprises it.

Advantageously, the two faces of the planar anode 10, respectively cathode 40, current collector substrate, are covered with an anode layer 20, respectively with a cathode layer 50, and optionally with a layer of electrolyte 30 or of separator 31, disposed on the anode layer 20, respectively on the cathode layer 50. In this case, the planar anode 10, respectively cathode 40, current collector substrate, will be used as a current collector for two adjacent elementary cells. Using these substrates in the batteries makes it possible to increase the production yield of rechargeable batteries with a high energy density and high power density.

The mechanical structure of one of the anode foils 2 is described hereinafter, with the understanding that the other anode foils 2 have an identical structure. Moreover, as shall be seen in what follows, the cathode foils 5 have a structure close to that of the anode foils 2.

As can be seen in FIG. 2, the notched anode foil 2e has a quadrilateral shape, substantially of the square type. It delimits a so-called perforated central area 4, wherein ladder-shaped grooves are made which shall be described hereinafter. In reference to the positioning of these ladder-shaped grooves, a so-called vertical direction YY of the foil is defined, which corresponds to the vertical direction of these ladder-shaped grooves, as well as a so-called horizontal direction XX of the foil, perpendicular to the direction YY. The central area 4 is bordered by a peripheral frame 6 that is solid, namely devoid of grooves. The function of this frame is in particular to ensure an easy handling of each foil.

The ladder-shaped grooves are distributed along lines L1 to Ly, disposed one beneath the other, as well as along rows R1 to Rx provided one next to the other. As non-limiting examples, in the framework of manufacturing micro-batteries of the surface-mounted component (hereinafter CMS) type, the anode and cathode foils used can be 100 mm×100 mm plates. Typically, the number of lines of these foils is comprised between 10 and 500, while the number of rows is comprised between 10 and 500. According to the desired capacity of the battery, its dimensions can vary and the number of lines and rows per anode and cathode foils can consequently be adapted. The dimensions of the anode and cathode foils used can be modulated according to need. As shown in FIG. 2, two adjacent lines are separated by bridges of material 8, of which H8 denotes the height, which is comprised between 0.05 mm and 5 mm. Two adjacent rows are separated by strips of materials 9, of which L9 denotes the width, which is comprised between 0.05 mm and 5 mm. These bridges 8 and strips 9 of material of the anode and cathode foils provide these foils with a mechanical rigidity that is sufficient for them to be able to be handled easily.

The ladder-shaped grooves 60, 61 comprise notches 76, 78, 86, 88 and H-shaped slots 70, 80. These H-shaped slots are through-slots, namely they open onto the opposite respectively upper and lower faces of the foil.

The H-shaped slots 70, 80 can be carried out in a manner known per se, directly on the planar current collector substrate, before any deposition of anode or cathode materials by chemical etching, by electroforming, by laser cutting, by microperforation or by stamping. These H-shaped slots 70, 80 can also be carried out on planar cathode current collector substrates covered with a layer of anode or cathode materials, on planar cathode current collector substrates covered beforehand with a layer of anode or cathode materials, and covered with a layer of electrolyte or of a separator, i.e. on anode or cathode foils in a manner known per se, for example by laser cutting (or laser ablation), by femtosecond laser cutting, by microperforation or by stamping. The H-shaped slots 70, carried out in all of the cathode foils, are superimposed. The H-shaped slots 80, carried out in all the anode foils, are superimposed.

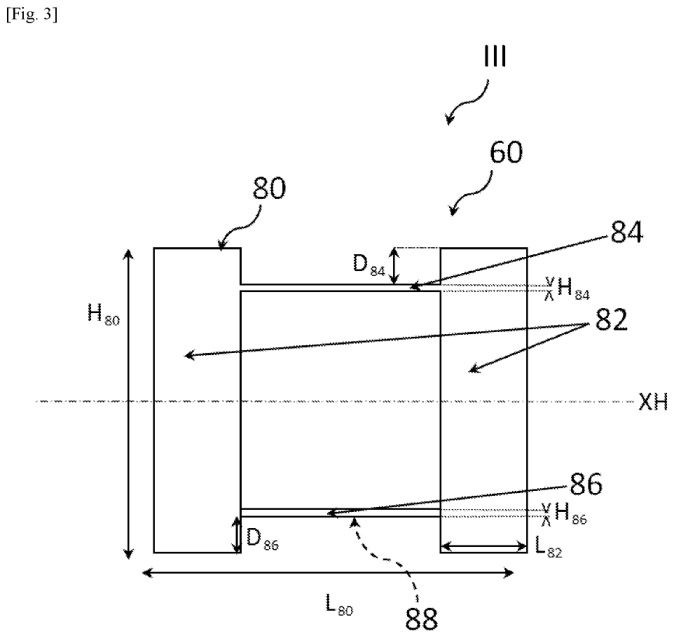

One of the ladder-shaped grooves 60 such as shown in FIG. 3 shall now be described, with the understanding that all of the cuts of the anode foil are identical. Each ladder-shaped groove 60 comprises a, H-shaped through-slot 80 formed by two main vertical and parallel cavities 82, which are connected in their upper portion by a horizontal channel 84, preferably perpendicular to the two main vertical and parallel cavities 82. Each groove further comprises, in the lower portion of the H-shaped slot, a first horizontal anode trench 86 and a second horizontal anode trench 88. As shown in particular in FIG. 3, the first 86 and second 88 horizontal anode trenches are carried out on either side of the anode foil 2 in such a way that the second horizontal anode trench 88 is carried out in the extension of the first horizontal anode trench 86.

The first and second anode trenches 86, 88 are free from any electrolyte material or separator and from any anode material. These first and second anode trenches 86, 88 are carried out in such a way as to remove any electrolyte material or separator, and any anode material, and to leave at least one portion of the planar anode current collector substrate defining a continuity area of the planar anode current collector substrate. The first and second anode trenches 86, 88 can be carried out via laser ablation.

The first and second anode trenches 86, 88 extend between the opposite longitudinal edges 1011, 1012 of the battery in a direction perpendicular to the main plane of the battery in such a way as to connect the two main vertical and parallel cavities 82 of each slot 80, called hereinafter anode slot.

The horizontal channel 84 on the one hand and the first and second horizontal anode trenches 86, 88 on the other hand, are mutually symmetrical seen from the top, with respect to the median axis of the Hs, which is noted as XH.

The anode foil 2 obtained after the carrying out of slots 80 and of notches forming the first and second horizontal anode trenches 86, 88 is called hereinafter notched anode foil 2e.

Note
H80 the height of the entire slot, that is typically comprised between 0.25 mm and 10 mm;
L80 its width, that is typically comprised between 0.25 mm and 10 mm;
L82 the width of each main vertical cavity, that is typically comprised between 0.02 mm and 5 mm;
H84 the height of each channel, that is typically comprised between 0.01 mm and 0.5 mm;
D84 the difference in heights between the top of the main vertical and parallel cavities 82 and the top of the horizontal channel 84, that is typically comprised between 0.05 mm and 2 mm;
H86 the height of each first horizontal anode trench 86, that is typically comprised between 0.01 mm and 0.5 mm;
D86 the difference in heights between the base of the main vertical and parallel cavities 82 and the base of each first horizontal anode trench 86, that is typically comprised between 0.05 mm and 2 mm.

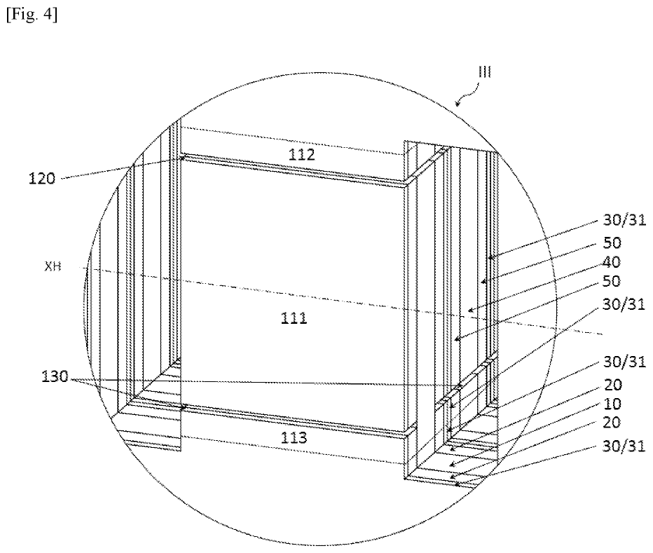

Each cathode foil 5 is also provided with different lines and rows of ladder-shaped grooves 61, provided in the same number as the ladder-shaped grooves 60. As shown in particular in FIG. 4, the structure of each ladder-shaped groove 61 is substantially similar to that of each ladder-shaped groove 60, namely in that this ladder-shaped groove 61 comprises two main vertical cathode cavities 72, connected by a horizontal channel 74. The dimensions of the main vertical cathode cavities 72 are identical to those of the main vertical anode cavities 82 and, similarly, the dimensions of the channels 74 are similar to those of the channels 84.

Seen from above, the main vertical cathode cavities 72 are superimposed with those 82. The only differences, between the ladder-shaped grooves 60 and 61, reside in the fact that the channels 74 are provided in the lower portion and that the first and second horizontal cathode trenches 76, 78 are provided in the upper portion. The first 76 and second horizontal cathode trenches 78 are carried out on either side of the cathode foil 5 in such a way that the second horizontal cathode trench 78 is carried out in the extension of the first horizontal cathode trench 76.

The first and second cathode trenches 76, 78 are free from any electrolyte material or separator and from any cathode material. These first and second cathode trenches 76, 78 are carried out in such a way as to remove any electrolyte or separator material, and any cathode material, and to leave at least one portion of the cathode current collector substrate defining a continuity area of the planar cathode current collector substrate. The first and second cathode trenches 76, 78 can be carried out via laser ablation in a manner known per se. The first and second cathode trenches 76, 78 extend between the opposite longitudinal edges 1011, 1012 of the battery in a direction perpendicular to the main plane of the battery in such a way as to connect the two main vertical and parallel cavities 72 of each slot 70, called hereinafter cathode slot 70.

As shown in particular in FIG. 4, the horizontal channel 74 on the one hand and the first and second horizontal cathode trenches 76, 78 on the other hand, are mutually symmetrical seen from the top, with respect to the median axis of the Hs, which is noted as XH.

The cathode foil 5 obtained after the carrying out of slots 70 and of notches forming the first and second horizontal cathode trenches 76, 78 is called hereinafter notched cathode foil 5e.

An alternating stack I of at least one notched anode foil 2e and of at least one notched cathode foil 5e is then carried out, in such a way as to obtain successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40.

The alternating stack I is carried out in such a way that:
for each anode slot 80 of at least one notched anode foil 2e, the anode trenches 86, 88 of at least the notched anode foil 2e, are disposed in the extension of the horizontal cathode channel 74 of the cathode slot 70 of the adjacent notched cathode foil 5e in a direction perpendicular to the main plane of the battery, and in such a way that,
for each cathode slot 70 of at least one notched cathode foil 5e, the cathode trenches 76, 78, of at least the notched cathode foil 5e, are disposed in the extension of the horizontal anode channel 84 of the anode slot 80, of the adjacent notched anode foil 2e in a direction perpendicular to the main plane of the battery.

It is supposed that the stack, described hereinabove, is subjected to steps aiming to ensure the overall mechanical stability thereof. These steps, of a type known per se, include in particular the thermopressing of the different layers. As shall be seen hereinbelow, this stack allows for the formation of individual batteries, of which the number is equal to the product between the number of lines Y and the number of rows X.

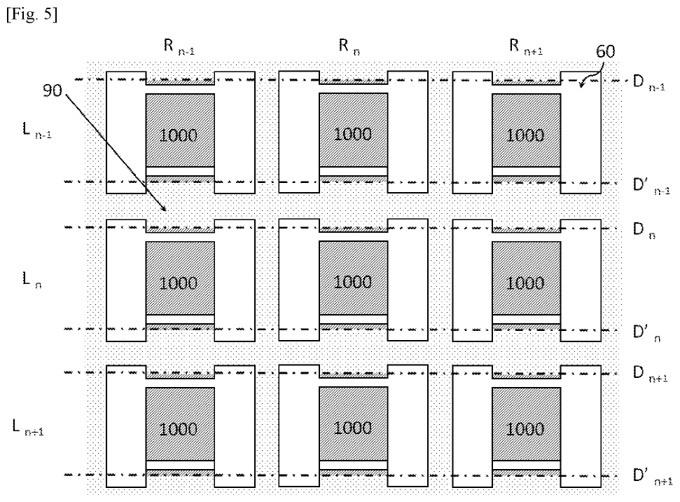

For this purpose, in reference to FIG. 5, three lines Ln−1 to Ln+1 are shown as well as three rows Rn−1 to Rn+1. In accordance with the invention, two cuts Dn and D′n are carried out by line of slots. Each cut, which is carried out in a through manner, namely it extends over the entire height of the stack, is carried out in a manner known per se. As non-limiting examples, mention will be made of cutting by sawing, in particular dicing, guillotine cutting or laser cutting.

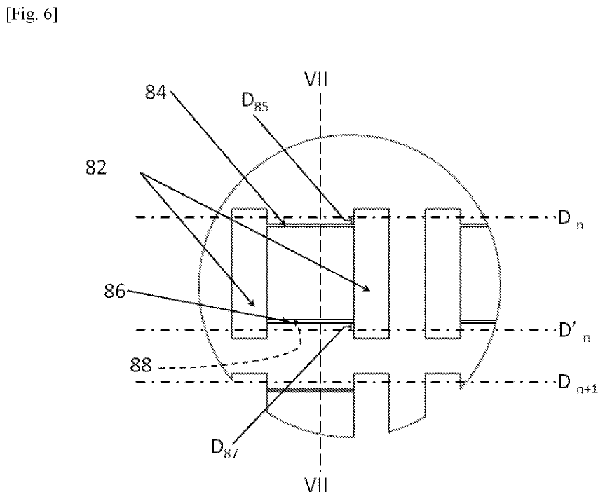

As shown in particular in FIG. 6, which is a view on a larger scale of one of the grooves of FIG. 5, each cut is carried out between a respective channel and the end facing the H-shaped slot. In these conditions, in reference to this FIG. 6, as non-limiting examples, note:
the distance D85 between the cut Dn and the face facing the horizontal channel 84 is comprised between 0.05 mm and 2 mm, with the understanding that this distance D85 is less than or equal to D84;

the distance D87 between the cut D′n and the face facing the first horizontal anode trench 86, comprised between 0.05 mm and 2 mm, with the understanding that this distance D87 is less than or equal to D86.

In reference again to FIG. 5, each final battery is delimited, at the top and at the bottom, by the two cuts Dn and D′n and, on the right and on the left, by the inside faces of the main vertical and parallel cavities.

This FIG. 5 shows in a hatched manner the batteries 1000 once cut along the cutting lines Dn and D′n. In addition, the areas 90 of foils of the stack are shown with a dotted filling, which do not form the batteries, while the volume of the slots in left in white.

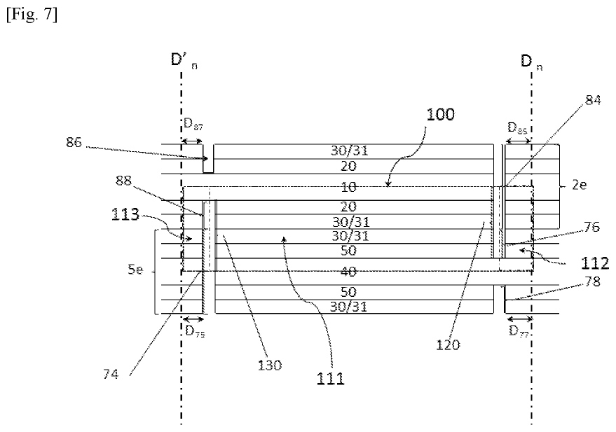

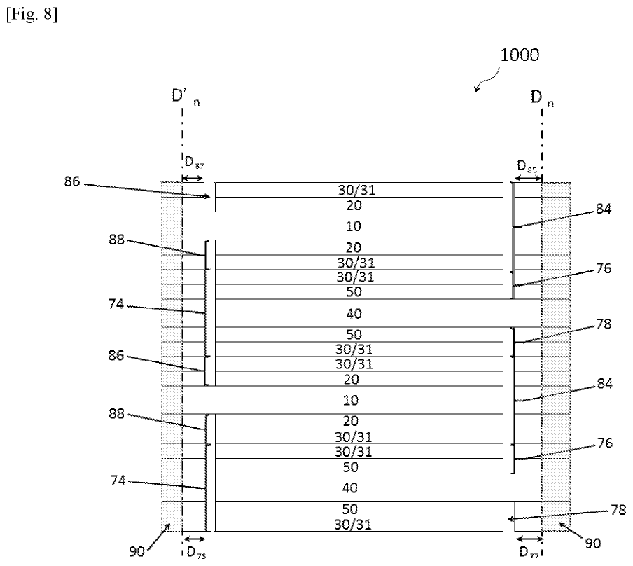

FIGS. 7 and 8 are cross-section views, taken according to the cutting line VII-VII that extends through the battery. In FIG. 7, only the arrangement of a notched anode foil 2e and of a notched cathode foil 5e, one with respect to the other, is shown. In FIG. 8, the alternating arrangement of two notched anode foils 2e and of two notched cathode foils 5e is shown. In the same figure, the zones 90 are referenced, also shown in FIG. 5, which correspond to material scrap, in particular scraps of anode, cathodes and electrolyte material or separator.

The notched anode foil 2e comprises a planar anode current collector substrate 10 covered with an anode layer 20, itself optionally covered with a layer of electrolyte 30 or of a separator 31 impregnated with an electrolyte. Each notched cathode foil 5e comprises a planar cathode current collector substrate 40 covered with an active layer of a cathode material 50, itself optionally covered with a layer of electrolyte 30 or of a separator 31 impregnated with an electrolyte. In order to prevent any electrical contact between two active layers of opposite polarity, i.e. between the anode layer 20 and the cathode layer 50, at least one layer of electrolyte 30 or of a separator 31 impregnated or later impregnated with an electrolyte is disposed between the anode layer 20 and the cathode layer 50. In FIG. 7 an elementary cell 100 is shown comprising successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40.

Each elementary cell 100 comprises a primary body 111, a secondary body 112 and a tertiary body 113. The secondary body 112 and the tertiary body 113 are disposed on either side of the primary body 111. Each one of the primary 111, secondary 112 and tertiary 113 bodies comprises successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40. The succession of the different layers is the same for the primary 111, secondary 112 and tertiary 113 body; the anode layer of the primary body is facing the anode layer of the secondary body and that of the tertiary body, the cathode layer of the primary body is facing the cathode layer of the secondary body and that of the tertiary body, and the layer of electrolyte or separator of the primary body is facing the layer of electrolyte or separator of the secondary body and that of the tertiary body. The secondary body 112 is separated from the primary body 111 by a notch 120 free from any anode, electrolyte, separator impregnated with an electrolyte, cathode and anode current collector substrate material, in such a way that said notch extends from a longitudinal edge 1011 to the opposite longitudinal edge of the battery 1012 in a direction perpendicular to the main plane of the battery.

The tertiary body 113 is separated from the primary body 111 by a recess 130 free from any anode, electrolyte, separator impregnated with an electrolyte, cathode and cathode current collector substrate material, in such a way that the recess 130 extends from a longitudinal edge 1011 to the opposite longitudinal edge of the battery 1012 in a direction perpendicular to the main plane of the battery.

Moreover, each notched anode, respectively notched cathode, foil has ladder-shaped grooves. Each groove 60, 61 comprises a horizontal channel 84, 74, a first 86, 76 and a second horizontal trench 88, 78 such as those shown in FIG. 7. The first 86, 76 and second horizontal trenches 88, 78 are carried out on either side of the anode/cathode foils in such a way that the second horizontal trench 88, 78 is carried out in the extension of the first horizontal trench 86, 76. Moreover each notched anode 2e and notched cathode 5e foil are arranged in such a way that:
the first 86 and second 88 horizontal anode trenches are disposed in the extension of the horizontal cathode channel 74 of the ladder-shaped groove 61 present on the adjacent notched cathode foil 5e, and in that
the first 76 and second 78 horizontal cathode trenches are disposed in the extension of the horizontal anode channel 84 of the ladder-shaped groove 60 present on the adjacent notched anode foil 2e.

This is a particularly advantageous characteristic of the invention, since this makes it possible to prevent the presence of a short-circuit at the lateral edges of the battery, to prevent the presence of leakage current, and to facilitate the making of electrical contact at the anode 1002 and cathode 1006 connection areas.

As a cross-section view, the main vertical cathode cavities 72 are superimposed with those 82. The only differences, between the ladder-shaped grooves 60 and 61, resides in the fact that the channels 74 are provided in the lower portion and that the first and second horizontal cathode trenches 76, 78 are provided in the upper portion. The first 76 and second 78 horizontal cathode trenches are carried out on either side of the cathode foil 5 in such a way that the second horizontal cathode trench 78 is carried out in the extension of the first horizontal cathode trench 76.

The first and second cathode trenches 76, 78 are free from any electrolyte material or separator and from any cathode material. The first and second cathode trenches 76, 78 extend between the opposite longitudinal edges 1011, 1012 of the battery in a direction perpendicular to the main plane of the battery in such a way as to connect the two main vertical and parallel cavities 72 of each slot 70, called hereinafter cathode slot 70.

As shown in particular in FIG. 4, the horizontal channel 74 on the one hand and the first and second horizontal cathode trenches 76, 78 on the other hand, are mutually symmetrical seen from the top, with respect to the median axis of the Hs, which is noted as XH.

The cathode foil 5 obtained after the carrying out slots 70 and notches forming the first and second horizontal cathode trenches 76, 78 is called hereinafter notched cathode foil 5e.

In FIGS. 7 and 8 note that the cut D′n is carried out both through the notched anode foil and the notched cathode foil, namely at a distance D75 from the channels of the ladder-shaped grooves 61 present on the notched cathode foils 5e, which also corresponds to the distance D87 from the first 86 and second horizontal anode trenches 88 of the ladder-shaped grooves 60 present on the notched anode foils 2e. The cut Dn is carried out both through the notched anode foil and the notched cathode foil, namely at a distance D85 from the channels of the ladder-shaped grooves 60 present on the notched anode foils 2e, which also corresponds to the distance D77 from the first 76 and second horizontal cathode trenches 78 of the ladder-shaped grooves 61 present on the notched cathode foils 5e. Carrying out cuts Dn and D′n through the notched anode foil and the notched cathode foil is a particularly advantageous characteristic of the invention, since this makes it possible to improve the quality of the cut with respect to the prior art, as is explained in greater detail hereinafter.

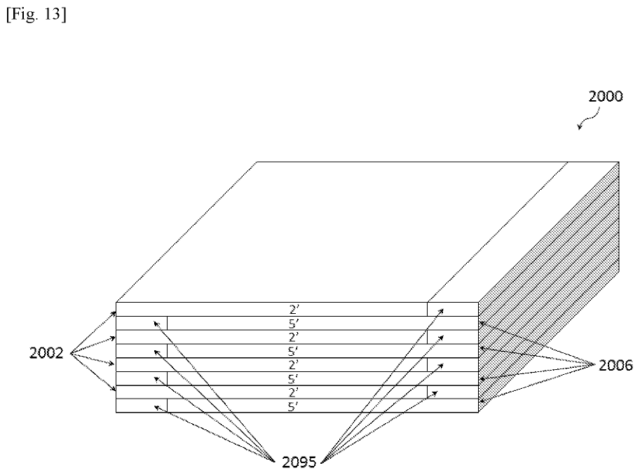

Application WO 2016/001584 describes stacks of several elementary cells, consisting of anode 2′ and cathode 5′ foils stacked alternately and offset laterally (cf. FIG. 13), encapsulated in an encapsulation system 2095 in order to ensure the protection of the cell of the battery 2000 with regards to the atmosphere. The cutting of these encapsulated stacks making it possible to obtain unitary batteries, with exposed anode 2002 and cathode 2006 connection areas, is carried out according to a cutting plane passing through an alternating succession of electrode and encapsulation system. Through the difference in density that exists between the electrode and the encapsulation system of the battery of the prior art, the cut carried out along this cutting plane induces a risk of pulling off of the encapsulation system at the approaches to the cutting plane, and thus the creation of short-circuits. In application WO 2016/001584, during the encapsulation, the encapsulation layer fills the interstices of the stack of foils bearing U-shaped cuts. This encapsulation layer introduced at these interstices is thick and does not adhere very well to the stack inducing this risk of pulling off of the encapsulation system 2095 during the later cutting.

According to the present invention, this risk is suppressed with the use of foils bearing ladder-shaped grooves, because the thermopressed mechanical structure in the shape of a ladder is extremely rigid at the approaches to the cut, due to the alternating superposition of cathode and anode foils. Using such a rigid structure, with the use of foils bearing cuts in the shape of a ladder, makes it possible to reduce the number of defects during cuts, increase the cutting speed and thus improve the production yield of the batteries.

According to the invention, the cuts D′n and Dn are carried out through notched anode foils 2e and notched cathode foils 5e of comparable density inducing a clean cut of better quality. In addition, the presence of notches 120 free from any anode, electrolyte, separator impregnated with an electrolyte, cathode and anode current collector substrate material as well as the presence of recesses 130 free from any anode, electrolyte, separator impregnated with an electrolyte, cathode and cathode current collector substrate material, prevents any risk of a short-circuit and of leakage current.

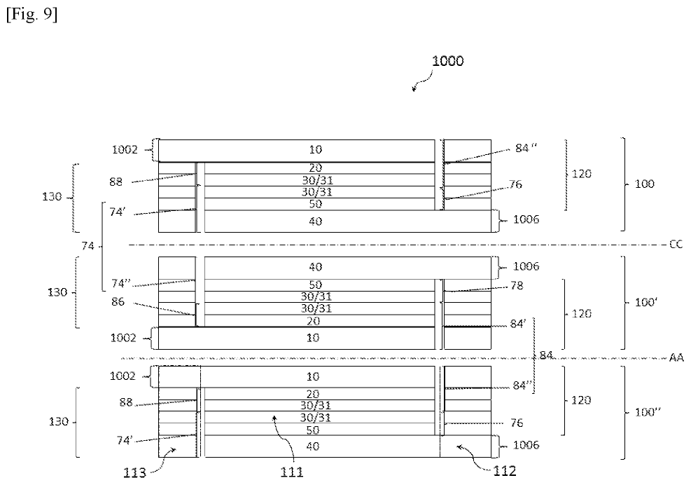

In reference to FIG. 9, one 1000 of the batteries is shown in an exploded manner in accordance with the invention comprising, as a non-limiting example, three elementary cells 100, 100′, 100″. Each elementary cell 100 comprises a primary body 111, a secondary body 112 and a tertiary body 113. The secondary body 112 and the tertiary body 113 are disposed on either side of the primary body 111. Each one of the primary 111, secondary 112 and tertiary 113 bodies comprises successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40. The secondary body 112 is separated from the primary body 111 by a notch 120 free from any anode, electrolyte, separator impregnated with an electrolyte, cathode and anode current collector substrate material. The notch 120 comprises either a portion of the channel 84 hereinafter 84″ and the first cathode trench 76, or a portion of the channel 84 hereinafter 84′ and the second cathode trench 78 as shown in FIG. 9. The portions 84′ and 84″ of the horizontal channel 84 are symmetrical with respect to the median axis AA of the anode current collector substrate. The blind end of the notch 120 of each elementary cell defines a continuity area of the cathode current collector, in such a way as to allow the making of electrical contact at the cathode connection area 1006.

Similarly, the tertiary body 113 is separated from the primary body 111 by a recess 130 free from any anode, electrolyte, separator impregnated with an electrolyte, cathode and cathode current collector substrate material. The recess 130 comprises either a portion of the channel 74 hereinafter 74″ and the first anode trench 86, or a portion of the channel 74 hereinafter 74′ and the second anode trench 88 as shown in FIG. 9. The portions 74′ and 74″ of the horizontal channel 74 are symmetrical with respect to the median axis CC of the cathode current collector substrate. The blind end of the recess 130 of each elementary cell defines a continuity area of the anode current collector, in such a way as to allow the making of electrical contact at the anode connection area 1002.

As shown in FIG. 9, each elementary cell comprises respectively upper and lower faces, each face being parallel to the main plane of the battery. Note that, each elementary cell comprises a recess 130 and a notch 120. The recess 130 opens onto a first face, here lower face of the elementary cell 100 and has a blind end that leaves a continuity area of the planar anode current collector substrate 10. The notch 120 opens onto a second face, here upper face of the elementary cell 100 and has a blind end that leaves a continuity area of the planar cathode current collector substrate 40. The anode connection areas 1002 and the cathode connection areas 1006 are preferably laterally opposite.

As shown in FIG. 9, the recess 130 of an elementary cell 100 extends in the extension of the recess 130 made in the adjacent elementary cell 100′ located below the elementary cell 100, in a direction perpendicular to the main plane of the battery. Similarly, the notch 120 of an elementary cell 100′ extends in the extension of the notch 120 made in the adjacent elementary cell 100″ located below the elementary cell 100′, in a direction perpendicular to the main plane of the battery.

As shown in FIG. 9, the planar anode current collector substrate 10 of an elementary cell 100′ can be placed next to the planar anode current collector substrate 10 of the adjacent elementary cell 100″. Similarly, the planar cathode current collector substrate 40 of an elementary cell 100 can be placed next to the planar cathode current collector substrate 40 of the adjacent elementary cell 100′.

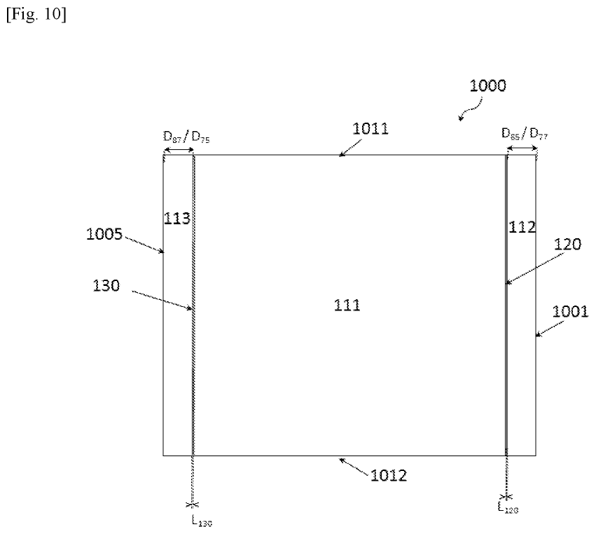

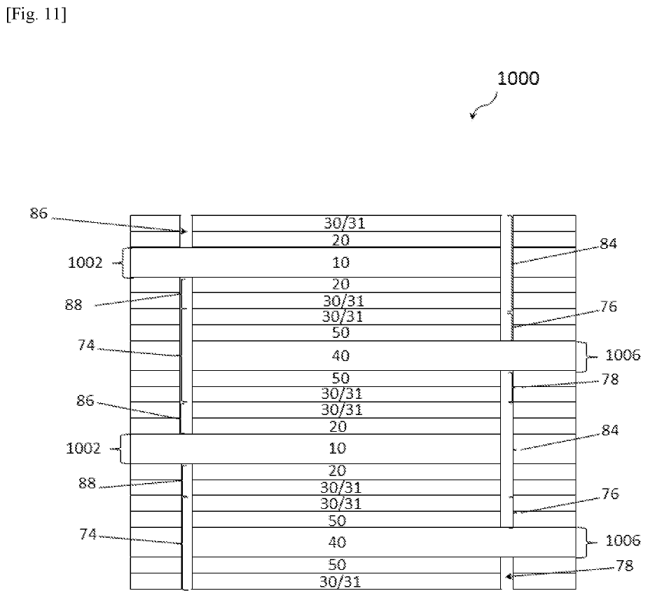

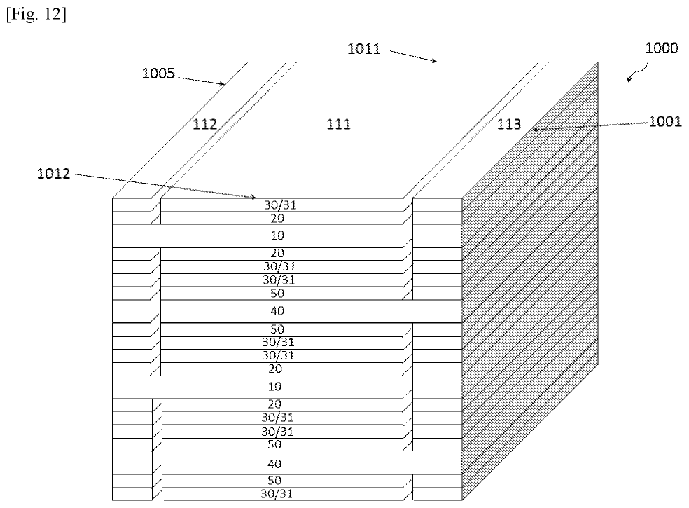

In an advantageous embodiment, the planar anode 10, respectively cathode 40, current collector substrate, can be used as a current collector for two adjacent elementary cells, as is in particular shown in FIG. 7. As explained hereinabove, the two faces of the planar anode 10, respectively cathode 40, current collector substrate, are covered with an anode layer 20, respectively with a cathode layer 50, and optionally with a layer of electrolyte 30 or of separator 31, disposed on the anode layer 20, respectively on the cathode layer 50. This makes it possible to increase the production yield of the batteries. Now in reference to FIGS. 10 to 12, one 1000 of the batteries is shown in accordance with the invention. On note 1001 and 1005 the lateral edges, 1011 and 1012 the longitudinal edges of this battery.

Each battery comprises at least one elementary cell 100. The elementary cell 100 comprises a primary body 111, a secondary body 112 and a tertiary body 113. The secondary body 112 and the tertiary body 113 are disposed on either side of the primary body 111. Each one of the primary 111, secondary 112 and tertiary 113 bodies comprises successively at least one planar anode current collector substrate 10, at least one anode layer 20, at least one layer of an electrolyte material 30 or of a separator impregnated with an electrolyte 31, at least one cathode layer 50, and at least one planar cathode current collector substrate 40. The secondary body 112 is separated from the primary body 111 by a notch 120 free from any anode, electrolyte, separator impregnated with an electrolyte, cathode and anode current collector substrate material. The notch 120, of which the width L120 corresponds to that of the channel 84 of the slot 80 (or of the ladder-shaped groove 60) described hereinabove, extends from a longitudinal edge 1011 to the opposite longitudinal edge of the battery 1012 in a direction perpendicular to the main plane of the battery. The notch 120 comprises either a portion 84″ of the channel 84 and the first cathode trench 76, or a portion 84′ of the channel 84 and the second cathode trench 78 as shown in FIG. 7.

The tertiary body 113 is separated from the primary body 111 by a recess 130 free from any anode, electrolyte, separator impregnated with an electrolyte, cathode and cathode current collector substrate material. The recess 130, of which the width L130 corresponds to that of the channel 74 of the slot 70 (or of the ladder-shaped groove 61) described hereinabove, extends from a longitudinal edge 1011 to the opposite longitudinal edge of the battery 1012 in a direction perpendicular to the main plane of the battery. The recess 130 comprises either a portion 74″ of the channel 74 and the first anode trench 86, or a portion 74′ of the channel 74 and the second anode trench 88 as shown in FIG. 7.

The width of the secondary body 112 corresponds to the distance D85/D77, such as described in reference to FIG. 6, 7 or 8. The width of the tertiary body 113 corresponds to the distance D87/D75, such as described in reference to FIG. 6, 7 or 8. In an advantageous embodiment, the distances D85/D77 and D87/D75 are equal.

The singular structure of the battery according to the invention makes it possible to prevent the presence of short-circuits at the lateral edges of the battery, to prevent the presence of leakage current and to facilitate the making of electrical contact at the anode 1002 and cathode 1006 connection areas. Indeed, the presence of notches 120 and recess 130 in the battery according to the invention prevents the lateral leaking of lithium ions and facilitates the balancing of the battery; the effective surfaces of the electrodes in contact with one another, and delimited by the notches 120 and the recesses 130 are substantially identical.

The effective surfaces of the electrodes of each elementary cell according to the invention are facing one another in such a way that the notch 120 and the recess 130 delimit the lateral edges of the primary body 111 of each elementary cell. The blind end of the recess 130 of each elementary cell defines a continuity area of the anode current collector, in such a way as to allow for the making of electrical contact at the anode connection area 1002. The blind end of the notch 120 of each elementary cell defines a continuity area of the cathode current collector, in such a way as to allow for the making of electrical contact at the cathode connection area 1006. The presence of a notch 120 and of a recess 130 within the elementary cell makes it possible to prevent the presence of a short-circuit at the lateral edges of the battery, to prevent the presence of leakage current, and to facilitate the making of electrical contact, and this, only at the anode 1002 and cathode 1006 connection areas.

Advantageously, after the carrying out of the stack of notched anode 2e and notched cathode 5e foils, the heat treatment of the latter allowing for the assembly of the battery is carried out at a temperature comprised between 50° C. and 500° C., preferably at a temperature less than 350° C., and/or the mechanical compression of the stack of notched anode and notched cathode foils to be assembled is carried out at a pressure comprised between 10 MPa and 100 MPa, preferably between 20 MPa and 50 MPa. In a particular embodiment, after the carrying out of the stack and the step of heat treatment of the latter, the stack is encapsulated by depositing an encapsulation system in order to ensure the protection of the cell of the battery with regards to the atmosphere. The encapsulation system has to be chemically stable, resist a high temperature and be impermeable to the atmosphere in order to perform its function as a barrier layer. Advantageously, the stack of notched anode and notched cathode foils according to the invention, can be covered with a sequence, preferably with z sequences, of an encapsulation system comprising:
a first dense and insulating cover layer, preferably selected from parylene, parylene F, polyimide, epoxy resins, silicone, polyamide and/or a mixture thereof, deposited on the stack of notched anode 2e and notched cathode 5e foils; and
a second cover layer comprised of an electrically-insulating material, deposited by atomic layer deposition on said first cover layer.

This sequence can be repeated z times with z ≥1. This multilayer sequence has a barrier effect. The more the sequence of the encapsulation system is repeated, the more substantial this barrier effect will be.

Typically, the first cover layer is selected from the group formed by: silicones (deposited for example via impregnation or via plasma enhanced chemical vapor deposition from hexamethyldisiloxane (HMDSO)), epoxy resins, polyimide, polyamide, poly-para-xylylene (also called poly(p-xylylene), known better as parylene), and/or a mixture thereof. This first cover layer makes it possible to protect the sensitive elements of the battery from its environment. The thickness of said first cover layer is, preferably, comprised between 0.5 μm and 3 μm.

Different variants of parylene can be used. Advantageously, the first cover layer can be made from parylene C, parylene D, parylene N (CAS 1633-22-3), parylene F or a mixture of parylene C, D, N and/or F. Parylene is a dielectric, transparent, semi-crystalline material that has high thermodynamic stability and excellent resistance to solvents as well as a very low permeability. Parylene also has barrier properties that make it possible to protect the battery from its external environment. The protection of the battery is increased when this first cover layer is made from parylene F. This first cover layer is advantageously obtained from the condensation of gaseous monomers deposited via chemical vapor deposition (CVD) on the surfaces, which makes it possible to have conformal, thin and uniform coverage of all the accessible surfaces of the stack. This first cover layer is advantageously rigid; it cannot be considered as a flexible surface.

The second cover layer is comprised of an electrically-insulating material, preferably inorganic. It is deposited by atomic layer deposition (ALD), in such a way as to obtain a conformal coverage of all the accessible surfaces of the stack covered beforehand with the first cover layer. The layers deposited via ALD are very fragile mechanically and require a rigid bearing surface in order to ensure their protective role. The deposition of a fragile layer on a flexible surface would lead to the formation of cracks, generating a loss of integrity in this protective layer. Moreover, the growth of the layer deposited via ALD is influenced by the nature of the substrate. A layer deposited via ALD on a substrate that has areas of different chemical natures will have inhomogeneous growth, that can generate a loss of integrity in this protective layer.

ALD deposition techniques are particularly well suited for covering surfaces that have a high roughness in an entirely sealed and conformal manner. They make it possible to carry out conformal layers, free of defects, such as holes (layers referred to as “pinhole free”, i.e. free of holes) and represent very good barriers. Their WVTR coefficient is very low. The WVTR coefficient (water vapor transmission rate) makes it possible to evaluate the permeance to water vapor of the encapsulation system. The lower the WVTR coefficient is, the tighter the encapsulation system is.

The second cover layer can be made from ceramic material, vitreous material or vitroceramic material, for example in the form of oxide, of the Al2O3 type, of nitride, of phosphates, of oxynitride, or of siloxane. This second cover layer has, preferably, a thickness comprised between 10 nm and 50 nm.

This second cover layer deposited via ALD on the first cover layer makes it possible on the one hand, to endure the tightness of the structure, i.e. to prevent the migration of water inside the object and on the other hand to protect the first cover layer, preferably made of parylene F, from the atmosphere, in particular from air and humidity, from thermal exposure in order to prevent the degradation thereof. This second cover layer thus improves the service life of the encapsulated battery.

The stack of notched anode 2e and notched cathode 5e foils thus encapsulated in this sequence of the encapsulation system, preferably in z sequences, can then be covered with a last cover layer in such a way as to mechanically protect the stack thus encapsulated and possibly provide it with an aesthetic aspect. This last cover layer protects and improves the service life of the battery. Advantageously this last cover layer is also chosen to resist a high temperature, and has a mechanical resistance that is sufficient to protect the battery during the later use thereof. Advantageously, the thickness of this last cover layer is comprised between 1 um and 50 μm. Ideally, the thickness of this last cover layer is about 10 μm to 15 μm; such a range of thickness makes it possible to protect the battery from mechanical damage.

This last cover layer is preferably with a base of epoxy resin, polyethylene naphthalate (PEN), polyimide, polyamide, polyurethane, silicone, sol-gel silica or organic silica. Advantageously, this last cover layer is deposited via dipping.

The stack of notched anode 2e and notched cathode 5e foils thus coated is then cut by any suitable means along the cutting lines D′n and Dn in such a way as to expose the anode and cathode connection areas and to obtain unitary batteries.

Terminations (electrical contacts) are added where the cathode, respectively anode connection areas, are apparent. These contact areas are, preferably, disposed on the opposite sides of the stack of the battery in order to collect the current (lateral current collectors). The terminations are disposed on at least the cathode connection area and on at least the anode connection area, preferably on the face of the coated and cut stack comprising at least the cathode connection area and on the face of the coated and cut stack comprising at least the anode connection area.

The connection areas are metalized using techniques known to those skilled in the art, preferably via immersion in a conductive epoxy resin and/or a bath of molten tin. Preferably, the terminations consist, at the approaches of the cathode and anode connection areas, of a first stack of layers comprising successively a first layer of a material loaded with graphite, preferably made of epoxy resin loaded with graphite, and a second layer comprising metal copper obtained from an ink loaded with nanoparticles of copper deposited on the first layer. This first stack of terminations is then sintered by infra-red flash lamp in such a way as to obtain a covering of the cathode and anode connections with a layer of metal copper.

According to the final use of the battery, the terminations can comprise, additionally, a second stack of layers disposed on the first stack of terminations comprising successively a first layer of a tin-zinc alloy deposited, preferably by dipping in a bath of molten tin-zinc, in order to ensure the tightness of the battery at least cost and a second layer with a pure tin base deposited via electrodeposition or a second layer comprising an alloy with a silver, palladium and copper base deposited on this first layer of the second stack.

Terminations make it possible to resume the alternatively positive and negative electrical connections on each one of the ends. These terminations make it possible to carry out the electrical connections in parallel between the different battery elements. For this, only the cathode connections exit on one end, and the anode connections are available on another end.

The method according to the invention is particularly adapted to the manufacture of all-solid-state batteries, i.e. batteries of which the electrodes and the electrolyte are solid and do not comprise a liquid phase, even impregnated in the solid phase.

The method according to the invention is particularly adapted to the manufacture of batteries considered as quasi-solid-state comprising at least one separator 31 impregnated with an electrolyte. The separator is, preferably, a porous inorganic layer that has:
a porosity, preferably, a mesoporous porosity, greater than 30%, preferably comprised between 35% and 50%, and more preferably between 40% and 50%,
pores of an average diameter D50 less than 50 nm.

The thickness of the separator is advantageously less than 10 μm, and preferably comprised between 2.5 μm and 4.5 μm, in such a way as to reduce the final thickness of the battery without lessening its properties. The pores of the separator are impregnated with an electrolyte, preferably, by a lithium ion carrier phase such as liquid electrolytes or an ionic liquid containing lithium salts. The “nanoconfined” or “nanotrapped” liquid in the porosities, and in particular in the mesoporosities, can no longer exit. It is linked by a phenomenon called here “absorption in the mesoporous structure” (which does not seem to have been described in the literature in the context of lithium-ion batteries) and it can no longer exit even when the cell is placed in a vacuum. The battery is then considered as quasi-solid-state.

The following marks are used in these figures and in the following description:

TABLE 1
Alphanumeric marks used in the present application

| Mark | Meaning | Mark | Meaning |
|---|---|---|---|
| 1000 | Battery according to the | I | Stack of foils of substrate, |
| | invention | | covered with a layer of |
| | | | electrode (anode or |
| | | | cathode) and with a foil of |
| | | | electrolyte or of a |
| | | | separator impregnated |
| | | | with an electrolyte |
| 1011, | Longitudinal edges of the | 1 | Substrate foil |
| 1012 | Battery 1000 | | |
| 1001, | Lateral edges of the | 2, | Anode foil |
| 1005 | battery 1000 | 2′ | |
| 1002 | Anode connection area | 2^{e} | Notched anode foil |
| 1006 | Cathode connection area | 5, | Cathode foil |
| | | 5′ | |
| 100, | Elementary cell | 5^{e} | Notched cathode foil |
| 100′, | | | |
| 100″ | | | |
| 111 | Primary body of 100 | 4 | Perforated central area of |
| | | | the cathode foil |
| 112 | Secondary body of 100 | 6 | Peripheral frame of the |
| | | | cathode foil |
| 113 | Tertiary body of 100 | 7 | Perforations present at |
| | | | the four ends of the foils |
| | | | of substrate, anode, |
| | | | cathode, electrolyte or of |
| | | | a separator impregnated |
| | | | with an electrolyte |
| 120 | Notch | 8 | Bridges of material |
| | | | between two lines |
| 130 | Recess | H₈ | Height of the bridges |
| L120 | Width of the notch | 9 | Strips of material |
| | between 111 and 112 | | between two rows |
| L130 | Width of the recess | L₉ | Width of the strips |
| | between 111 and 113 | | |
| 10 | Planar anode current | XX | Longitudinal or horizontal |
| | collector substrate | | direction of the stack |
| 20 | Anode layer | YY | Vertical or transversal |
| | | | direction of the stack |
| 30 | Layer of an electrolyte | L | Line of slots in the shape |
| | material | | of a ladder |
| 31 | Layer of a separator | R | Row of slots in the shape |
| | impregnated with an | | of a ladder |
| | electrolyte | | |
| 50 | Cathode layer | 70 | H-shaped slots in the |
| | | | cathode foils, cathode |
| | | | slot |
| 40 | Planar cathode current | XH | Median horizontal axis of |
| | collector substrate | | the H72-shaped slots |
| 80 | H-shaped slots in the | D, | Cut |
| | anode foils, anode slot | D′, | |
| | | Dn, | |
| | | D′n, | |
| | | Dn + 1, | |
| | | D′n + 1 | |
| H50 | Total height of the H- | H₇₀ | Total height of the H- |
| | shaped slot | | shaped slot |
| L80 | Total width of the H- | L₇₀ | Total width of the H- |
| | shaped slot | | shaped slot |
| 82 | Main vertical cavities of | 72 | Main vertical cavities of |
| | 80 | | 70 |
| L82 | Width of each main | L₇₂ | Width of each main cavity |
| | cavity 82 | | 72 |
| 84 | Horizontal channel of 80 | 74 | Horizontal channel of 70 |
| 84, | Portion of the horizontal | 74, | Portion of the horizontal |
| 84″ | channel 84 belonging to | 74″ | channel 74 belonging to |
| | an elementary cell called | | an elementary cell called |
| | hereinafter portion of the | | hereinafter portion of the |
| | horizontal channel | | horizontal channel |
| H84 | Height of the horizontal | H₇₄ | Height of the horizontal |
| | channel 84 | | channel 74 |
| D84 | Distance between the top | D₇₄ | Distance between the top |
| | of 82 and of 84 | | of 72 and of 74 |
| 86 | First horizontal trench of | 76 | First horizontal trench of |
| | 80 | | 70 |
| H86 | Height of the first | H₇₅ | Height of the first |
| | horizontal trench of 80 | | horizontal trench of 70 |
| D85 | Distance between the | D₇₅ | Distance between the |
| | base of 82 and of 86 | | base of 72 and of 76 |
| 88 | Second horizontal trench | 78 | Second horizontal trench |
| | of 80 | | of 70 |
| H88 | Height of the second | H₇₈ | Height of the second |
| | horizontal trench of 80 | | horizontal trench of 70 |
| 90 | Material scrap | 91 | Material scrap |
| D85 | Distance between the cut | D₇₅ | Distance between the cut |
| | Dn and the face facing | | D′n and the face facing |
| | the horizontal channel 84 | | the horizontal channel 74 |
| D87 | Distance between the cut | D₇₇ | Distance between the cut |
| | D′n and the face facing | | Dn and the face facing |
| | the first horizontal trench | | the first horizontal trench |
| | 86 or the second | | 76 or the second |
| | horizontal trench 88 | | horizontal trench 78 |
| AA | Madian axis of the anode | CC | Madian axis of the |
| | current collector | | cathode current collector |
| | substrate | | substrate |
| 60, | Grooves in the shape of a | 2000 | Battery according to prior |
| 61 | ladder | | art |
| 2002 | Anode connection zone | 2006 | Cathode connection zone |
| 2095 | Encapsulation system | | |

1-18. (canceled)

19. A battery, comprising:
at least one elementary cell, said elementary cell that includes successively at least one planar anode current collector substrate, at least one anode layer, at least one layer of an electrolyte material or a separator impregnated with an electrolyte, at least one cathode layer, and at least one planar cathode current collector substrate;
a first longitudinal edge and a second longitudinal edges opposite to said first longitudinal edge;
a first lateral edge having at least one anode connection area; and
a second lateral edge having at least one cathode connection area that is laterally opposite to said anode connection area,
wherein:
each elementary cell includes a primary body, a secondary body and a tertiary body,
said secondary body and said tertiary body are arranged on either side of said primary body in a manner such that each one of the primary body, secondary body and tertiary body includes successively the at least one planar anode current collector substrate, the at least one anode layer, the at least one layer of an electrolyte material or the separator impregnated with an electrolyte, the at least one cathode layer, and the at least one planar cathode current collector substrate,
said secondary body is separated from the primary body by a notch free from any anode, electrolyte, separator impregnated with an electrolyte, cathode, and anode current collector substrate material, in a manner such that said notch extends from said first longitudinal edge to said second longitudinal edge in a direction perpendicular to a main plane of the battery, and
said tertiary body is separated from the primary body by a recess free from any anode, electrolyte, separator impregnated with an electrolyte, cathode, and cathode current collector substrate material, in a manner such that that said recess extends from said first longitudinal edge to said second longitudinal edge in a direction perpendicular to the main plane of the battery.

20. The battery of claim 19, further comprising a plurality of elementary cells, wherein all notches of each one of the elementary cells are superimposed, in a direction perpendicular to the main plane of the battery, in a manner such that each planar cathode current collector substrate collects the cathode current of the elementary cell through the cathode connection area, and that all recesses of each one of the elementary cells are superimposed, in a direction perpendicular to the main plane of the battery, in a manner such that each planar anode current collector substrate collects the anode current of the elementary cell through the anode connection area.

21. The battery of claim 19, further comprising an encapsulation system entirely covering four of six faces of said battery, with two remaining faces comprises an anode connection area and a cathode connection area.

22. The battery of claim 21, wherein the encapsulation system comprises:
at least one first cover layer deposited on the battery, said at least one first cover layer being selected from a group consisting of parylene, parylene F, polyimide, epoxy resins, silicone, polyamide, sol-gel silica, organic silica and/or a mixture thereof;
at least one second cover layer deposited by atomic layer deposition on said at least first cover layer, said at least one second cover layer comprising an electrically-insulating material, wherein a sequence of at least one first cover layer and of at least one second cover layer is repeated z times, with z ≥1.

23. The battery of claim 19, further comprising terminations to cover the anode connection area and the cathode connection area.

24. The battery of claim 23, wherein the terminations comprise:
a first layer of a material loaded with graphite disposed on at least the cathode connection area and/or at least the anode connection area;
a second dense layer of metal copper disposed on the first layer of the terminations.

25. The battery of claim 24, wherein the terminations comprise a third layer with a tin-tin zinc alloy base, disposed on the second layer.

26. The battery of claim 25, wherein the terminations comprise a fourth layer with a tin base or a base of a silver, palladium and copper alloy, disposed on the third layer.

27. The battery of claim 19, wherein the width of said notch is between 0.01 mm and 0.5 mm.

28. The battery of claim 19, wherein the width of said recess is between 0.01 mm and 0.5 mm.

29. The battery of claim 19, wherein the width of each secondary body is between 0.5 mm and 20 mm.

30. The battery of claim 19, wherein the battery is a lithium-ion battery.

31. A method for manufacturing a battery having at least one elementary cell that successively includes at least one planar anode current collector substrate, at least one anode layer, at least one layer of an electrolyte material or of a separator impregnated with an electrolyte, at least one cathode layer, and at least one planar cathode current collector substrate, said method comprising:
(a) providing at least one anode foil of planar anode current collector substrate covered with an anode layer, and covered or not with a layer of an electrolyte material or of a separator impregnated with an electrolyte, said anode foil having at least one anode slot that includes two main vertical anode cavities and parallel cavities which are connected in upper portions thereof by a horizontal anode channel substantially perpendicular to the two main anode vertical cavities, the main vertical anode cavities being configured to delimit longitudinal edges of the battery;
(b) providing at least one cathode foil of planar cathode current collector substrate covered with a cathode layer, and covered or not with a layer of an electrolyte material or of a separator impregnated with an electrolyte, said cathode foil having at least one cathode slot that includes two main vertical cathode cavities and parallel cavities which are connected in upper portions thereof by a horizontal cathode channel substantially perpendicular to the two main vertical cathode cavities, the main vertical cathode cavities being configured to delimit the longitudinal edges of the battery;
(c) carrying out a first notch and a second notch in a vicinity of each said at least one anode slot and said at least one cathode slot, respectively, of at least said at least one anode foil and said at least one cathode foil respectively, in a manner that forms anode trenches and cathode trenches respectively, in a direction perpendicular to a main plane of the battery and in a direction parallel to the horizontal anode channel of the at least one anode slot and to the horizontal cathode channel of the at least one cathode slot respectively, wherein:
said first notch and said second notch are made on either side of the at least one anode foil and the at least one cathode foil,
the second notch is made in an extension of the first notch,
the anode trenches obtained from the first notch are free from any electrolyte material or separator impregnated with an electrolyte and from any anode material,
and the cathode trenches obtained from the second notch are free from any electrolyte material or separator impregnated with an electrolyte, and from any cathode material, and
said anode trenches and said cathode trenches extend between opposite longitudinal edges of the battery in a direction perpendicular to the main plane of the battery in such a manner to connect the two main vertical anode cavities and parallel cavities of each anode slot, respectively, to connect the two main vertical cathode cavities and parallel cavities of each cathode slot, thereby obtaining a notched anode foil and a notched cathode foil,
(d) carrying out an alternating stack of at least one notched anode foil and at least one notched cathode foil in a such manner to obtain successively at least one planar anode current collector substrate, at least one anode layer, at least one layer of an electrolyte material or of a separator impregnated with an electrolyte, at least one cathode layer, and at least one planar cathode current collector substrate, wherein
for each anode slot of at least one said notched anode foil, the anode trenches of at least the notched anode foil are disposed in the extension of the horizontal cathode channel of the cathode slot of an adjacent notched cathode foil in a direction perpendicular to the main plane of the battery,
and for each cathode slot of at least one said notched cathode foil, the cathode trenches of at least the notched cathode foil are disposed in the extension of the horizontal anode channel of the anode slot of an adjacent notched anode foil in a direction perpendicular to the main plane of the battery,
(e) carrying out a heat treatment and/or a mechanical compression of the alternating stack of said at least one notched anode foil and said at least one notched cathode foil to thereby form a consolidated stack; and
(f) carrying out a first cut and a second cut that each extend at least partially inside said anode slot and said cathode slot according to a plane parallel to the horizontal anode channel and the cathode channel, the first cut extending between the horizontal anode channel of the anode slot and an end facing the longitudinal edges, the second cut extending between the horizontal cathode channel of the cathode slot and an end facing the longitudinal edges to thereby form a cut stack exposing at least the anode connection area and the cathode connection area.

32. The method of claim 31, further comprising, after performing step (e):
(g) encapsulating the consolidated stack by depositing:
at least one first cover layer on the battery, said at least one first cover layer being selected from a group consisting of parylene, parylene F, polyimide, epoxy resins, silicone, polyamide, sol-gel silica, organic silica and/or a mixture thereof, and then
at least one second cover layer deposited by atomic layer deposition on said at least first cover layer, said at least one second cover layer comprising an electrically-insulating material, wherein a sequence of at least one first cover layer and of at least one second cover layer is repeated z times, with z ≥1.

33. The method of claim 31, further comprising, after performing step (f), carrying out terminations of the battery by successively depositing on at least the anode connection area and the cathode connection area:
a first layer of a material loaded with graphite,
a second dense layer of metal copper disposed on the first layer of the terminations.

34. The method of claim 33, comprising a third layer with a tin-tin zinc alloy base, disposed on the second layer of the terminations.

35. The method of claim 34, comprising a fourth layer with a tin base or with a base of a silver, palladium, and copper alloy, disposed on the third layer of the terminations.

36. The method of claim 31, wherein the first notch and the second notch forming the anode trenches and the cathode trenches are carried out via laser ablation.

37. The method of claim 31, wherein the first cut and the second cut are carried out via laser.

38. The method of claim 31, wherein each elementary cell defines on a first face, a continuity area of the planar anode current collector substrate and an emerging notch, and on an opposite face, a continuity area of the planar cathode current collector substrate and an emerging recess.

39. The method of claim 38, wherein the continuity area of the planar anode current collector substrate is located facing the emerging notch, and the continuity area of the planar cathode current collector substrate is located facing the recess in a direction perpendicular to the plane of the battery.

40. The method of claim 31, wherein:
the planar anode current collector substrate is the anode current collector substrate of two adjacent elementary cells, and the planar cathode current collector substrate is the cathode current collector substrate of two adjacent elementary cells.
